(19) United States
(12) Patent Application Publication
(10) Pub. No.: US 2020/0031541 A1
(43) Pub. Date: Jan. 30, 2020

(54) NEEDLE, NEEDLE ASSEMBLY INCLUDING SAME, AND ASSOCIATED MANUFACTURING AND USE METHODS THEREFOR

(71) Applicant: CSP TECHNOLOGIES, INC., Auburn, AL (US)

(72) Inventors: Herve Pichot, Chennevieres-sur-Marne (FR); Jean-Pierre Giraud, Auburn, AL (US); Franklin Lee Lucas, JR., Opelika, AL (US)

(73) Assignee: CSP TECHNOLOGIES, INC., Auburn, AL (US)

(21) Appl. No.: 16/500,868

(22) PCT Filed: Apr. 5, 2018
(86) PCT No.: PCT/US2018/026295

§ 371 Date: Oct. 4, 2019

Related U.S. Application Data
(60) Provisional application No. 62/481,985, filed on Apr. 5, 2017.

(51) Int. Cl. B65D 51/00; B29C 45/00

(52) U.S. Cl. CPC B65D 51/002; B29K 2077/10; B29C 45/0001

(57) ABSTRACT

A needle includes a hollow needle body. The needle body includes a sharp and a proximal end portion located opposite the sharp and defining an opening. The needle body has at least one thru hole and a lumen. The thru hole is located at or proximate the sharp. The lumen is provided between the thru hole and the opening of the end portion. The needle body is constructed of a blend of a polymeric base material for providing flexibility, and a fiber material for providing rigidity.

### CROSS-REFERENCE TO RELATED APPLICATION

This application claims priority from and claims the benefit of U.S. Provisional Patent Application Ser. No. 62/481985, filed Apr. 5, 2017, and entitled “NEEDLE AND NEEDLE ASSEMBLY INCLUDING SAME, AND ASSOCIATED MANUFACTURING AND USE METHODS THEREFOR.”

### FIELD

The presently disclosed technology relates generally to needles. In one embodiment, the presently disclosed technology further relates to needle assemblies including needles. In another embodiment, the presently disclosed technology further relates to methods of manufacturing needles and components associated therewith. In yet another embodiment, the presently disclosed technology further relates to methods of using needle assemblies and components associated therewith.

### BACKGROUND

For certain applications, the transfer of fluids from one enclosure and/or liquid stream to another must be done in such a way as to prevent contamination of the fluid being transferred. For example, in the pharmaceutical, biotech, diagnostic and dairy industries, fluids (e.g., samples) are routinely transferred from a dispensing enclosure to a receiving enclosure, without introducing contaminating material into either the dispensing enclosure or the receiving enclosure. The word “enclosure” as used herein refers to any closed containment structure without respect to its size or shape. Thus, the word “enclosure” as used herein includes such small enclosures as cans, which may be used in shipping starter bacteria from a culture lab. On the other end of the size spectrum, the word “enclosure” as used herein includes large tanks, which may have capacities of several thousand gallons, or more, such as are used in the dairy processing industry.

Fluid receiver fittings are commonly employed to facilitate the transfer of fluids from dispensing enclosures to receiving enclosures. One type of fluid receiver fitting is disclosed in Applicant's Int'l. Pat. Pub. No. WO 2016/187557, the contents of which are incorporated by reference herein in its entirety. One known method of transferring fluids from a dispensing enclosure to a receiving enclosure involves using a metal hypodermic needle to pierce a septa of a fluid receiver fitting, and take a sample of the fluid in the receiving enclosure and/or liquid stream. Although beneficial, use of a metal hypodermic needle for this purpose has certain drawbacks. For example, conventional metal hypodermic needles are rigid and not flexible. This presents a challenge to operators such as, for example, truck drivers in the dairy industry, who are often not trained, but are required to inefficiently align the needle and vertically insert it through the septa of the fluid receiver fitting in order to take a sample of the fluid from the dispensing enclosure. Failure to achieve near perfect vertical insertion of the needle may result in misalignment of the needle with the septum. This could frustrate or even prevent an operator's attempt to puncture the septum in order to effectuate the desired fluid transfer.

Additionally, use of conventional metal hypodermic needles presents a problem known as coring. More specifically, because the metal needle is so sharp, piercing of the septa often dislodges pieces of the septa, which get stuck in, and block, the primary opening of the needle. The sharpness of the metal needle also presents a potential safety hazard to operators, who may inadvertently puncture and wound their skin on the needle tip. Furthermore, handling of the metal needles often involves operators touching the needle, which could contaminate the needle and consequently the fluid with which the needle comes in contact. One other drawback of this method is that because the needles are rigid and sharp, proper disposal of the needles must be in a designated “sharps” container, which may not always be available.

### SUMMARY

There is a need for a needle and associated components that overcomes one or more of the above-mentioned drawbacks associated with conventional metal hypodermic needles. The presently disclosed technology overcomes those drawbacks and provides additional benefits.

Accordingly, in one aspect, there is provided a needle. The needle includes a hollow needle body. The needle body includes a sharp and a proximal end portion located opposite the sharp and defining an opening. The needle body has at least one thru hole and a lumen. The thru hole is located at or proximate the sharp. The lumen provides fluid communication between the at least one thru hole and the opening of the end portion. The needle body is constructed of a blend of a polymeric base material for providing flexibility, and a fiber material for providing rigidity.

As another aspect of the disclosed concept, a needle assembly includes a container body and the aforementioned needle disposed therein, optionally enclosed by a lid connected to the body.

As another aspect of the disclosed concept, a method of manufacturing the aforementioned needle includes providing a mold defining a cavity corresponding to a profile of the needle body and at least one core corresponding to the lumen, the thru hole(s) and opening in the proximate end, injecting a blend of a polymeric material and a fiber material (e.g., glass fibers) into the cavity, allowing the blend to harden, and removing the finished needle from the cavity.

As another aspect of the disclosed concept, a method of using the aforementioned needle assembly is provided. This method includes opening a lid connected to the container body to provide access to the needle body, coupling a device to the end portion of the needle body to provide a fluid fitting configured for facilitating fluid communication from the needle to an enclosure to which the device is optionally connected, removing the needle body from the container body, inserting the sharp into a liquid-holding enclosure, and withdrawing a quantity of the liquid from the enclosure, the quantity of liquid passing through the at least one thru hole and into the lumen.

### BRIEF DESCRIPTION OF THE DRAWINGS

The foregoing summary, as well as the following detailed description of the presently disclosed technology, will be better understood when read in conjunction with the appended drawings, wherein like numerals designate like elements throughout. For the purpose of illustrating the presently disclosed technology, there are shown in the drawings various illustrative embodiments. It should be understood, however, that the presently disclosed technology is not limited to the precise arrangements and instrumentalities shown. In the drawings:

FIG. 1 is an isometric view of a container or needle assembly, in accordance with one non-limiting embodiment of the disclosed concept;

FIG. 2 is a partially exploded isometric view of the container assembly of FIG. 1;

FIG. 3 is a cross-section view of the container assembly of FIG. 1;

FIG. 4 is an isometric view of a needle for the container assembly of FIG. 1;

FIG. 5 is another isometric view of the needle of FIG. 4;

FIG. 6 is a magnified view of a portion of the needle of FIG. 4;

FIG. 7 is an isometric view of a container body for the needle assembly of FIG. 1;

FIG. 8 is another isometric view of the container body of FIG. 7;

FIG. 9 is a partial sectional view of a portion of a fluid receiver fitting, showing the needle of FIG. 4 and FIG. 5 penetrating therethrough into a liquid stream;

FIG. 10 is an isometric view, partially cutaway, of another needle in accordance with another non-limiting embodiment of the disclosed concept;

FIG. 11 is a front view of the needle of FIG. 10;

FIG. 12 is a section view of the needle of FIG. 11;

FIG. 13 is a cross-section view of the needle of FIG. 11;

FIG. 14 is an isometric view of a needle in accordance with another non-limiting embodiment of the disclosed concept;

FIG. 15 is another isometric view of the needle of FIG. 14;

FIG. 16 is an elevation view of the needle of FIG. 14;

FIG. 17 is another elevation view of the needle of FIG. 14;

FIG. 18 is yet another elevation view of the needle of FIG. 14;

FIG. 19 is still elevation view of the needle of FIG. 14;

FIG. 20 is a bottom plan view of the needle of FIG. 14;

FIG. 21 is a top plan view of the needle of FIG. 14;

FIG. 22 is an illustration showing the needle of FIGS. 10-13 being formed in a mold, shown with portions of the mold removed for clarity, and with the needle partially hidden or transparent in order to show other structures;

FIG. 23 is a magnified view of a portion of the illustration of FIG. 22;

FIG. 24 is an illustration showing the needle of FIGS. 14-21 being formed in a mold, shown with portions of the mold removed for clarity, and with the needle partially hidden or transparent in order to show other structures; and

FIG. 25 is a magnified view of a portion of the illustration of FIG. 24.

### DETAILED DESCRIPTION

While systems, devices and methods are described herein by way of examples and embodiments, those skilled in the art recognize that the presently disclosed technology is not limited to the embodiments or drawings described. Rather, the presently disclosed technology covers all modifications, equivalents and alternatives falling within the spirit and scope of the appended claims. Features of any one embodiment disclosed herein can be omitted or incorporated into another embodiment.

Any headings used herein are for organizational purposes only and are not meant to limit the scope of the description or the claims. As used herein, the word “may” is used in a permissive sense (i.e., meaning having the potential to) rather than the mandatory sense (i.e., meaning must). Unless specifically set forth herein, the terms “a,” “an” and “the” are not limited to one element but instead should be read as meaning “at least one.” As used herein, the word “unitary” means a component that is created as a single, integral piece or unit. Under this definition, a component that includes pieces that are created separately and then coupled together as an assembled unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one. The terminology includes the words noted above, derivatives thereof and words of similar import.

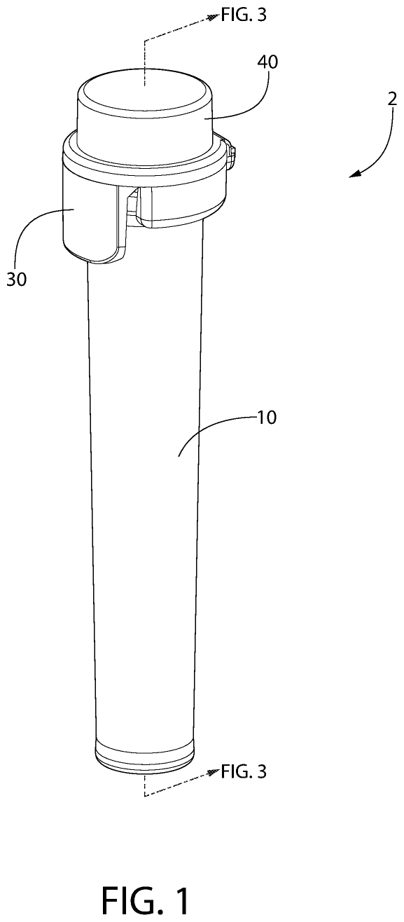

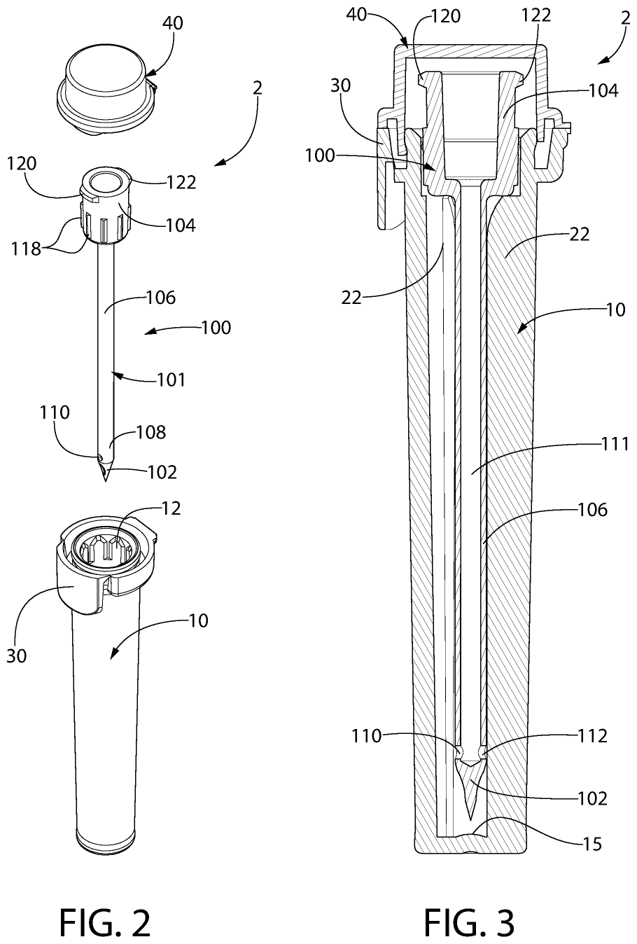

Referring now in detail to the various figures, wherein like reference numerals refer to like parts throughout, FIGS. 1, 2, and 3 illustrate a container or needle assembly, generally designated 2, in accordance with one non-limiting embodiment of the disclosed concept. Referring to FIG. 2, in one embodiment needle assembly 2 includes container body 10, lid 40, and needle 100 that has hollow needle body 101. Container body 10 defines interior 12, and needle body 101 is optionally configured to be housed within interior 12 prior to use. As such, container body 10 provides a reliable mechanism to minimize contamination of needle body 101 prior to use. In one embodiment, the container body 10 is sized to hold two ounces.

In one exemplary embodiment, needle body 101 is a unitary component that is made by an injection-molding process, as will be discussed below. Additionally, lid 40 and container body 10, which in one example embodiment are pivotally connected by a hinge, e.g. a living hinge, are cooperatively configured to enclose needle body 101 prior to use. This provides advantages in terms of minimizing contamination that might otherwise occur when needle body 101 is used by an operator, as will be discussed below. Furthermore, in an optional aspect, needle body 101 is constructed of a blend of a polymeric base material and a fiber material. This unique material blend of needle body 101 provides advantages in terms of ease of use, disposal, and improved safety, as will be discussed in greater detail below.

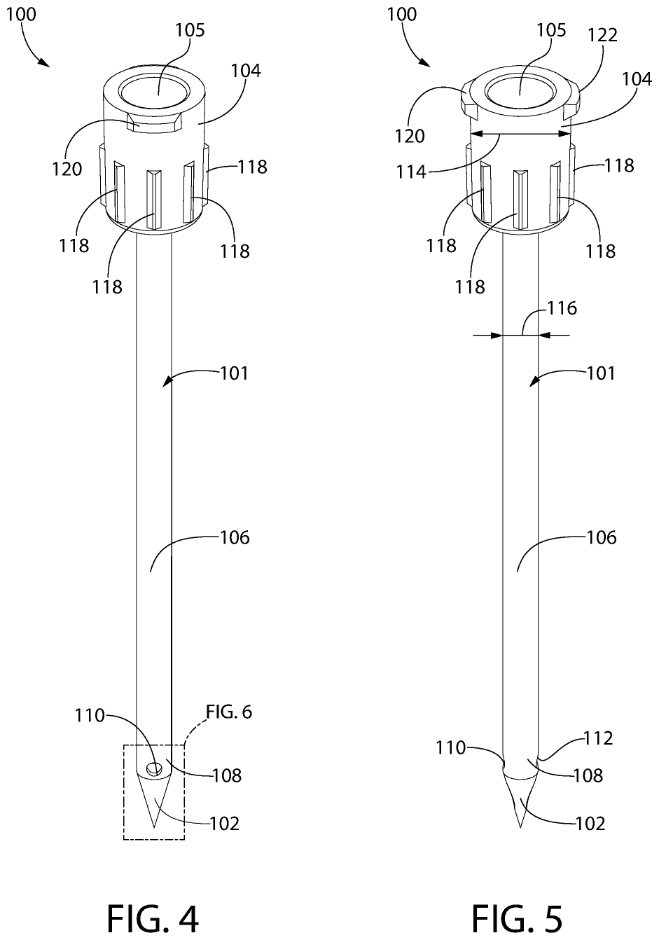

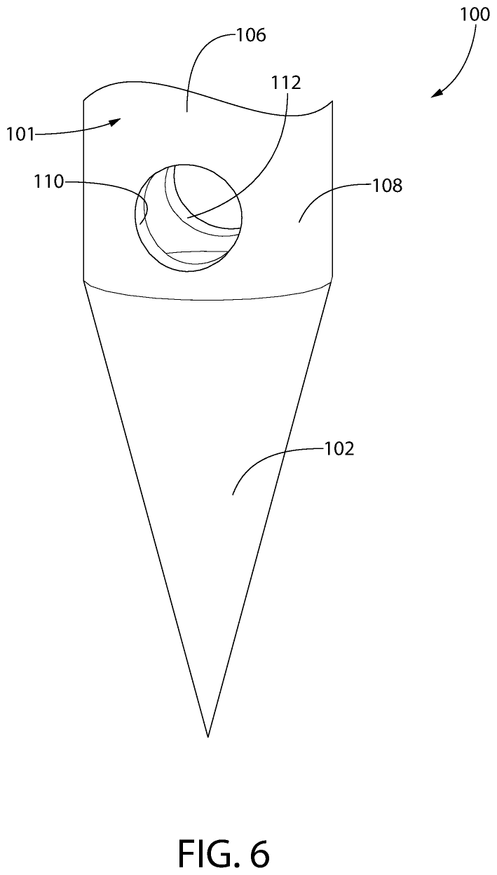

Referring to FIGS. 4 and 5, in one embodiment needle body 101 has a distal sharp 102, a proximal end portion 104 located opposite distal sharp 102, and a tubular sidewall 106 extending from sharp 102 to proximal end portion 104. Optionally, sharp 102 is conical in shape, i.e., having the geometry of an inverted cone. Proximal end portion 104 defines opening 105, and in operation, fluid is able to flow through opening 105. Tubular sidewall 106 includes distal portion 108 from which sharp 102 extends. As shown in FIG. 6, distal portion 108 optionally has at least one or a plurality of edge portions (two exemplary opposing edge portions 110, 112 are shown in FIG. 6) each defining a respective thru hole. The opposing thru holes defined by edge portions 110, 112 are each in fluid communication with opening 105 of proximal end portion 104. In other words, needle body 101 has a lumen 111 (see FIG. 3) provided between and fluidly connecting the thru hole(s) and opening 105. In this manner, and as will be discussed below, fluid is able to be withdrawn from an enclosure and/or liquid stream through the thru holes defined by edge portions 110,112, passed through the lumen 111 of tubular sidewall 106, and exited through opening 105.

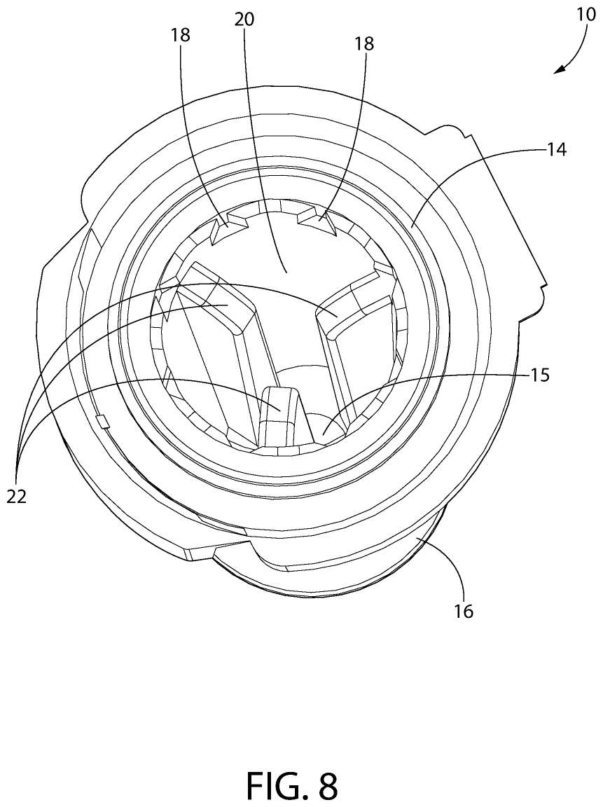

Referring again to FIG. 5, in one embodiment proximal end portion 104 has a first outer diameter 114 and the tubular sidewall 106 has a second outer diameter 116 less than first outer diameter 114. In this manner, the relatively wide proximal end portion 104 allows needle body 101 to be easily coupled to a fitting (e.g., without limitation, a luer lock adapter) without requiring an operator to manually and directly touch and thus contaminate needle body 101. Moreover, the relatively wide proximal end portion 104 is optionally configured to be maintained on elongated guide rail portions (three exemplary guide rail portions 22 are shown in FIG. 8) within the interior 12 of the container body 10. In this way, as shown in FIG. 3, the needle body 101 is suspended above or spaced-apart from a floor 15 of the interior 12 of the container body 10 so that the sharp 102 is not dulled by contact with a portion of the container body 10 during storage.

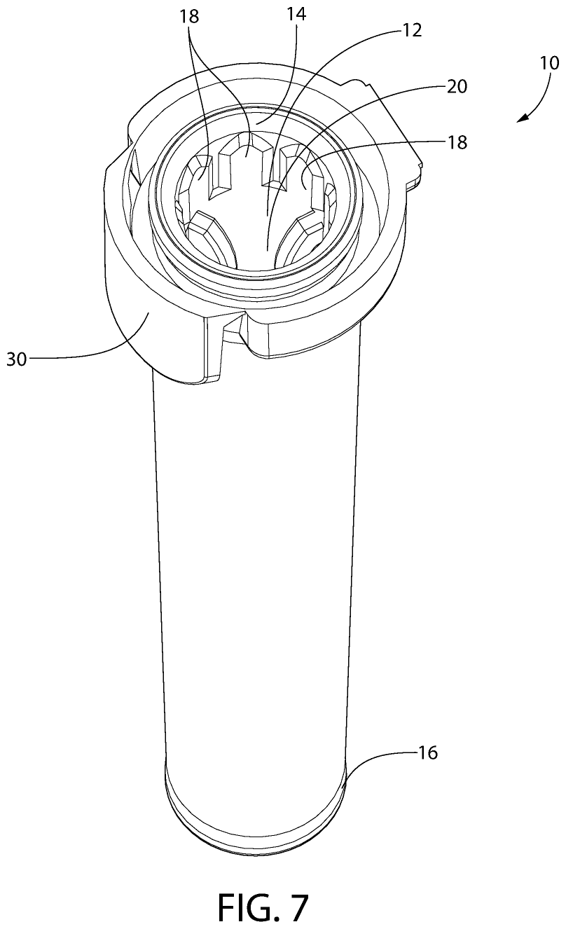

As shown in FIGS. 7 and 8, needle body 101 optionally has a plurality of spaced-apart protrusions 18, each extending radially outwardly from proximal end portion 104. Protrusions 18 can be sized, shaped and/or structured to interlock with container body 10 in order to maintain needle body 101 within container body 10, as will be discussed below. Additionally, as shown in FIG. 2, needle body 101 optionally has one or more gripping portions (two exemplary opposing gripping portions 120, 122 are shown in FIGS. 7 and 8) each extending radially outwardly from proximal end portion 104. Gripping portions 120, 122 provide a mechanism by which a fitting (e.g., without limitation, a luer lock adapter) can couple to needle body 101 in order to allow fluid to be withdrawn from an enclosure and/or liquid stream.

In one embodiment, as shown in FIGS. 7 and 8, container or needle body 10 includes first end portion 14, second end portion 16 located opposite and distal first end portion 14, and at least one or a plurality of spaced-apart protrusions 18 extending radially inwardly from first end portion 14. Container body 10 optionally includes an inner surface 20 extending from first end portion 14 to floor 15 at second end portion 16. In one embodiment protrusions 18 form part of the inner surface. Optionally, at least one or a plurality of elongated and spaced-apart guide rail portions (three exemplary guide rail portions 22 are shown in FIG. 8) each extend radially inwardly from inner surface 20. When needle body 101 is located within interior 12 of container body 10, protrusions 118 of needle body 101 interlock with protrusions 18 of container body 10 in order to reliably maintain (e.g., prevent rotation of) needle body 101 within container body 10. More specifically, each of the corresponding protrusions 118 of needle body 101 is structured to be located between a corresponding pair of adjacent protrusions 18 of container body 10. In this manner, when needle body 101 is located within interior 12, rotational movement of needle body 101 with respect to container body 10 is advantageously minimized and/or eliminated. It will, however, be appreciated that suitable alternative mechanisms of maintaining a needle body within a container body are also contemplated by the disclosed concept. Furthermore, in the exemplary embodiment, guide rail portion(s) 22 (FIG. 8) each extend from proximate first end portion 14 to proximate second end portion 16 and provide a mechanism to guide needle body 101 into interior 12 during assembly. More specifically, and with reference to FIG. 3, it will be appreciated that tubular sidewall 106 is centrally located with respect to guide rail portions 22. In addition, it is noted that top surfaces of guide rail portions 22 operate to provide the ridge 15 from which needle body 101 is suspended or spaced-apart from, as discussed above.

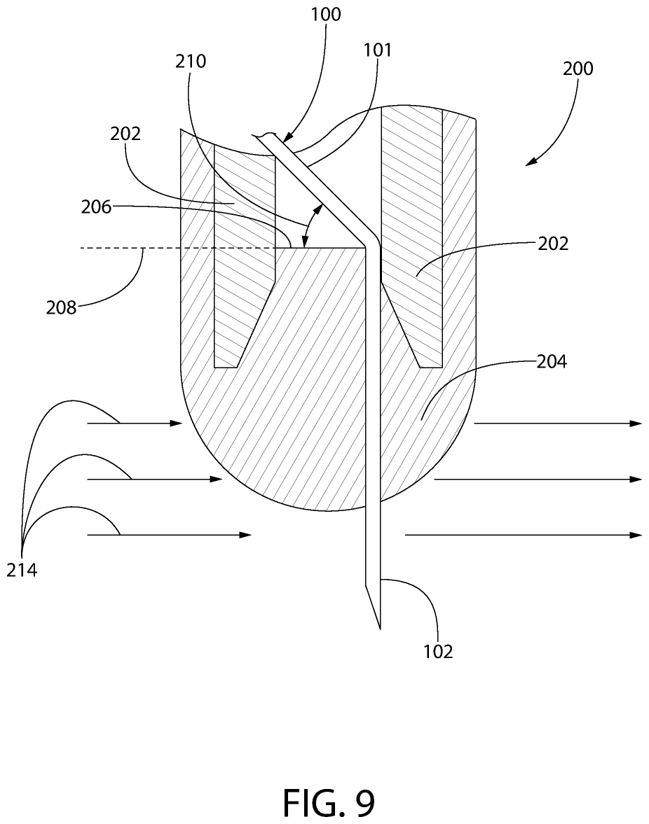

FIG. 9 shows a simplified view of a portion of a fluid receiver fitting, generally designated 200 (e.g., such as one disclosed in Int'l. Pat. Pub. No. WO 2016/187557, which is incorporated by reference herein in its entirety), and a portion of needle 100 penetrating therethrough. As shown, fluid receiver fitting 200 includes one or more guide channels 202 and a septum 204. Septum 204 has a penetration surface 206 that is located in a plane 208. As shown in FIG. 9, needle 100 has pierced penetration surface 206 and has been pushed all the way through septum 204, extending out from a distal end thereof. As such, sharp 102 and distal portion 108 are disposed in a liquid stream 214 within an enclosure. In this configuration, liquid from the liquid stream 214 may be withdrawn through needle 100 via the edge portions 110, 112 (defining corresponding thru holes) in distal portion 108, the lumen 111 and ultimately the opening 105, as discussed above.

As stated above, in one embodiment needle body 101 is constructed of a blend of a polymeric base material and a fiber material. In one exemplary embodiment, the polymeric base material is a nylon material or polyimide material that allows needle body 101 to be relatively flexible, and the fiber material includes glass fibers that provide strength and/or an appropriate level of rigidity to needle body 101. Optionally, the blend making up the needle body comprises from 50% to 85% polymeric base material and from 50% to 15% fiber material. In one embodiment, the blend comprises 85% to 75% polymeric base (e.g., nylon) and 15% to 25% fiber material (e.g., glass fiber). In yet another embodiment, the blend comprises about 70% polymeric base (e.g., nylon) and about 30% fiber material. In still another embodiment, the blend comprises 80% polymeric base (e.g., nylon) and 20% fiber material.

The purpose of this blend is to balance rigidity with flexibility, since both characteristics (in proper balance) are important for functioning of the needle 100. The blend should render the needle body 101 strong and rigid enough to pierce through septum 204, which in an exemplary embodiment is made of silicone or a thermoplastic elastomer. On the other hand, the blend should also render the needle body 101 sufficiently flexible to facilitate insertion through septum 204. Such flexibility is beneficial because as explained above, conventional needles, which are typically made of metal, are generally required to be inserted into fluid receiver fittings vertically. This process that can sometimes be difficult for untrained operators. A somewhat flexible needle, according to an optional aspect of the disclosed concept, is more forgiving and allows an operator to insert the needle 100 into septum 204 at an angle, as now described in detail.

As shown in FIG. 9, in use needle body 101 can be engaged with one guide channel 202 of fluid receiver fitting 200. Due to the unique material nature of needle body 101, needle body 101 is advantageously able to deflect, or be bent while disposed within guide channel 202. More specifically, needle body 101 is configured to be optionally oriented at an angle 210 of from 40° to 90° with respect to plane 208 of penetration surface 206. Notably, the needle body 101 is configured to withstand such deflection without breaking through normal use, yet provide sufficient rigidity to penetrate septum 204. As a result, needle 100 is significantly easier to use in operation, as compared to conventional metal needles, which could be burdensome for an operator to align and position with respect to fluid receiver fittings in order to withdraw fluid samples. That is, conventional metal needles generally must be inserted vertically or near vertically into fluid receiver fittings, while needle 100, due to its unique material nature, may be inserted vertically or at more forgiving and convenient angles into fluid receiver fittings.

Moreover, the unique material nature of needle 100 provides additional benefits in terms of safety and disposal. For example, because needle 100 is not made of metal, there is a significantly reduced likelihood that operators handling and working with needle 100 will be stuck, or stabbed, with sharp 102, which may not be as sharp and rigid as a conventional metal needle. Additionally, disposing of needle 100 is relatively simple. More specifically, once an operator has finished using needle 100, the operator can simply and safely snap needle 100 in half (or into multiple parts) manually and throw away the remnants. Conventional metal needles, by way of contrast, generally require separate sharps disposal containers, by virtue of their being relatively hard and unable to be broken into smaller components. Sharps containers are not always conveniently available, so the needle 100 advantageously facilitates more convenient disposal compared to conventional metal needles.

The geometry of needle assembly 2 can provide significant advantages in terms of minimizing contamination and coring. First, as stated above, needle body 101 is located within interior 12 of container body 10 prior to use, and lid 40 and container body 10 cooperatively enclose needle body 101 prior to use. In the exemplary embodiment, container body 10 has a tamper evident feature 30 in order to provide a visual indication to an operator that the enclosed needle 100 has not previously been used. Thus, when the operator desires to use needle 100, the operator can physically remove tamper evident feature 30 from container body 10, open lid 40, and be provided with access to needle 100, which is relatively clean in that it would not have previously been contacted since its manufacture and original insertion into container body 10. Furthermore, by being provided with gripping portions 120, 122, the operator can directly couple a fitting (e.g., without limitation, a luer lock adapter) to gripping portions 120, 122, remove needle 100 from container body 10, and then use the needle 100 to withdraw a fluid sample from one enclosure to another, without ever having to touch sharp 102 or tubular sidewall 106. As sharp 102 and tubular sidewall 106 are the portions of needle body 101 that pierce and engage with septum 204, the fluid being withdrawn is advantageously not exposed to contamination from surface contact with the operator. Furthermore, the fluid in the enclosure which flows over and about sharp 102 and tubular sidewall 106 advantageously remains essentially free of contamination from the operator's fingers.

Second, as stated above and as shown most clearly in FIG. 6, edge portions 110, 112 that define thru holes are advantageously provided in distal portion 108 of tubular sidewall 106. This is distinct from conventional metal needles in which fluid withdrawing thru holes are provided in sharps of the needles. Thus, in accordance with the disclosed concept, when needle body 101 pierces septum 204, there is a significantly reduced likelihood that portions of septum 204 (e.g., elastomeric material) will become dislodged and enter and/or potentially plug the thru holes defined by edge portions 110, 112, a situation which would be known as “coring.” Coring may occur with conventional metal needles having an axial hole through its sharp, in response to the normal force of the needle pressing into the septum. On the other hand, in the exemplary embodiment, because the thru holes are not provided axially through sharp 102, the likelihood of coring is significantly reduced. It will, however, be noted that in certain aspects, the disclosed concept is not necessarily limited to this configuration.

In accordance with an aspect of the disclosed concept a method of manufacturing needle 100 through injection molding is provided. The method includes the steps of providing a mold defining a cavity corresponding to an outer profile of needle body 101 and one or more cores corresponding to the lumen 111, the edge portions 110, 112 and the opening 105. The method further includes the steps of injecting a blend of a polymeric material and a fiber material (as disclosed above) into the cavity, allowing the blend to harden to form the needle 100, separating the one or more cores from the mold cavity and removing the formed needle 100 from the cavity.

Additionally, a method of using needle assembly 2 includes the steps of opening container body 10 to provide access to needle body 101, coupling a device (e.g., without limitation, a luer lock adapter) to end portion 104 of needle body 101, removing needle body 101 from container body 10, inserting sharp 102 into an enclosure comprising a liquid, and withdrawing a quantity of the liquid from the enclosure, the quantity of liquid passing through at least one of the thru holes defined by edge portions 110, 112. The method may further include piercing penetration surface 206 of septum 204 with sharp 102.

Optionally, in any embodiment, the needle 100 and the container 200 are made by injection molding.

In an optional aspect, the disclosed concept is directed to a method of assembling the needle assembly 2. The method includes, optionally in an in-line automated process, the steps of providing the container body 10 in an opened position, disposing or providing the needle 100 into or in the interior 12 of the container body 10 so as to retain proximal end portion 104 of needle 100 onto guide rail portions 22 provided within interior 12 of container body so as to suspend needle body 101 and sharp 102 above floor 15 of interior such that in a resting position (e.g., during storage) sharp 102 does not physically contact container body 10. Optionally, this method includes effectuating the aforementioned steps in an aseptic environment so as to prevent microbial contamination through surface contact of needle 100 and interior 12. Optionally, this method further includes closing lid 40, thereby enclosing needle 100 within container. Optionally, this method further includes providing a tamper evident feature 30 on the closed container, which must be permanently removed or destroyed in order to open the container to gain access to the needle 100.

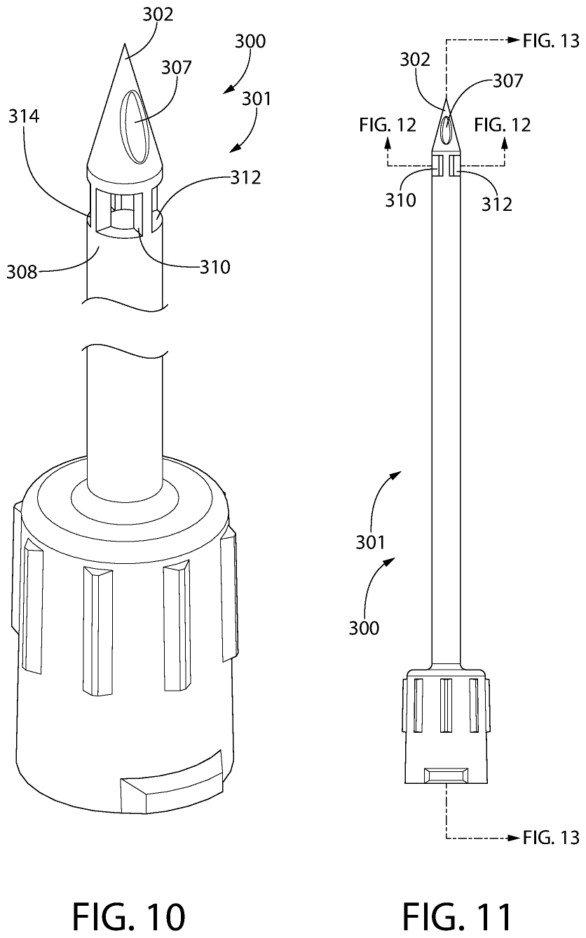

FIGS. 10-13 show various views of another needle 300, in accordance with another non-limiting embodiment of the disclosed concept. Similar or identical structure between the embodiments of FIGS. 1-9 and FIGS. 10-13 is distinguished in FIGS. 10-13 by a reference number with a magnitude three hundred (300) greater than that of FIGS. 1-9. Description of certain similarities between the embodiments may be omitted herein for convenience and brevity only.

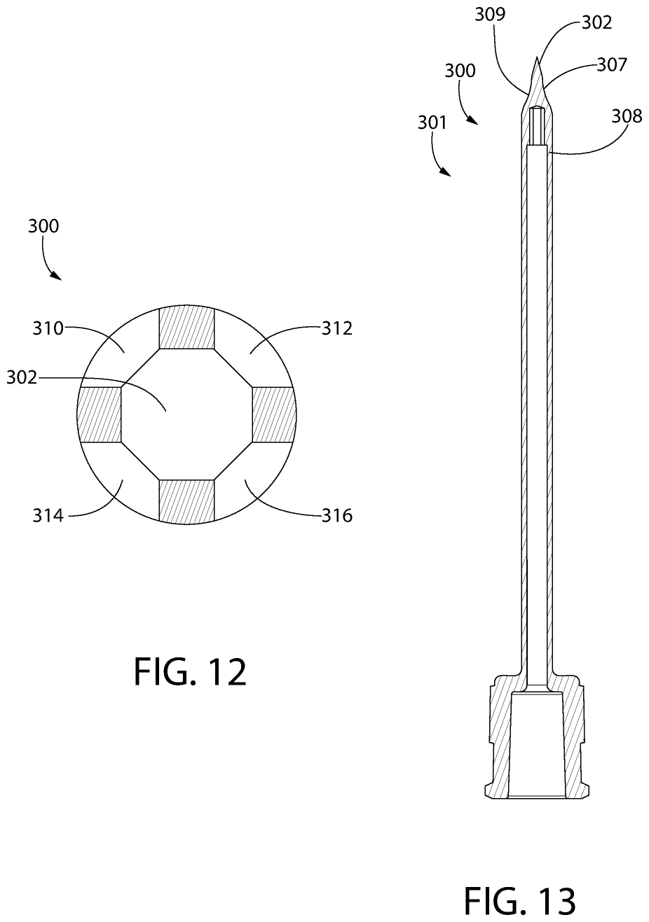

Needle 300 can be constructed of the same material as, and made by the same processes as, needle 100, discussed above. Additionally, needle 300 includes needle body 301 having distal portion 308 and sharp 302 extending from distal portion 308, like needle 100. However, unlike distal portion 108 of needle 100, which has one or two edge portions 110, 112, distal portion 308 of needle 300 has four edge portions 310, 312, 314, 316 (see FIGS. 10 and 12) each defining a thru hole. The purpose of the additional edge portions in distal portion 308 is to increase the amount of fluid flow into the lumen of needle body 301. It will thus be appreciated that a needle in accordance with the disclosed concept may have any suitable number of thru holes in a distal portion. Optionally, each edge portion 310, 312, 314, 316 is spaced from sharp 302 an equal distance.

Additionally, needle 300 has an improved mechanism or means to minimize the amount of friction between needle 300 and a thermoplastic elastomer (e.g., septum 204, shown in FIG. 9) through which needle 300 might penetrate. More specifically, sharp 302 of needle body 301 has at least one or a plurality of concave recessed regions 307, 309 (see FIG. 13). Optionally, recessed regions 307, 309 are grooved indents or concave depressions in sharp 302. When sharp 302 pierces a thermoplastic elastomer (e.g., septum 204, shown in FIG. 9), the amount of contact area between sharp 302 and the thermoplastic elastomer will be relatively small, as compared to a needle not having recessed regions (e.g., the prior art or needle 100). That is, the grooved regions 307, 309 are structured such that the thermoplastic elastomer will generally not engage them, or will exert only a relatively small force on them, thus minimizing friction between sharp 302 and the thermoplastic elastomer during penetration. Conventional metal needles, by way of contrast, are generally manufactured by grinding an end portion of a metal tube, a process that results in the sharp of the needle being integral with the sidewall. Thus, conventional metal needles, which are devoid of separate concave sharps extending from corresponding sidewalls, do not provide for recessed regions in a sharp that extends from a sidewall. It will be appreciated that the sharp can have any number of grooved regions 307, 309 as desired for the particular application.

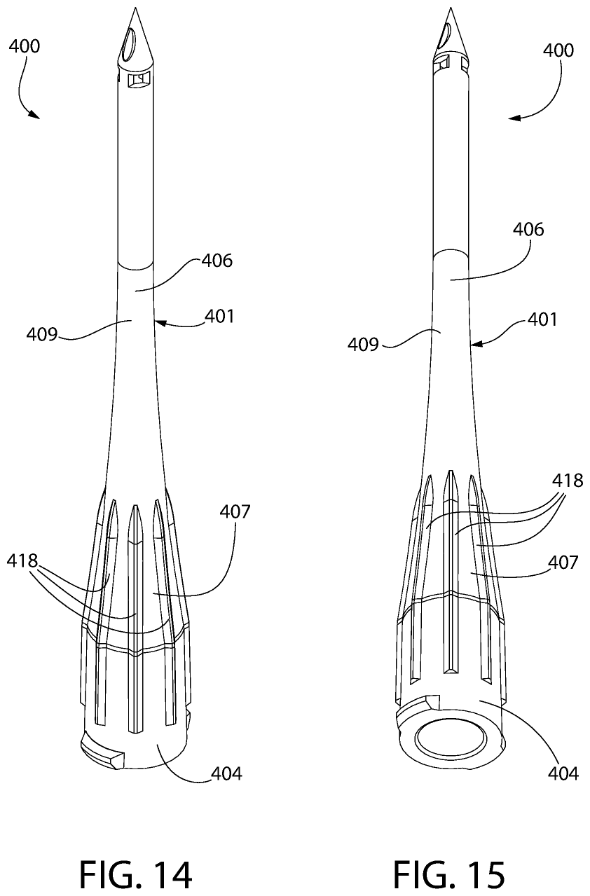

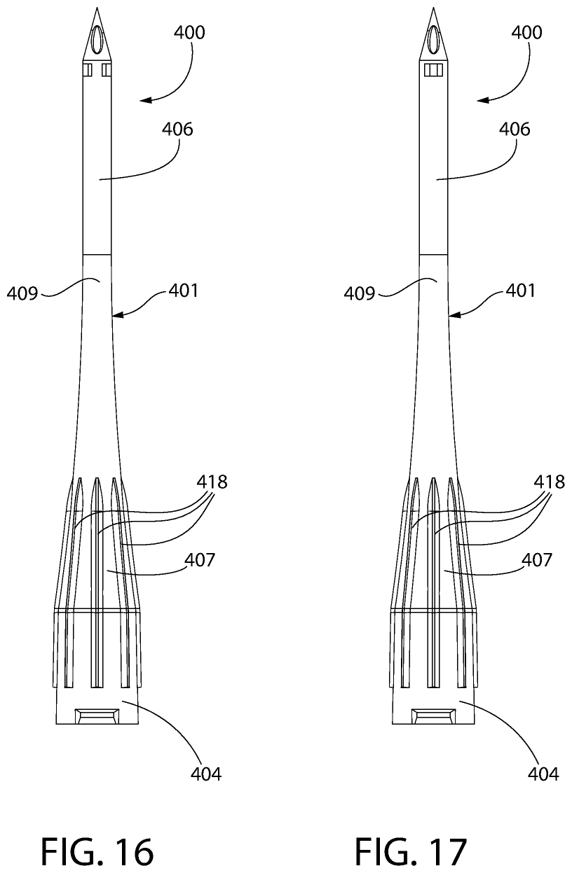

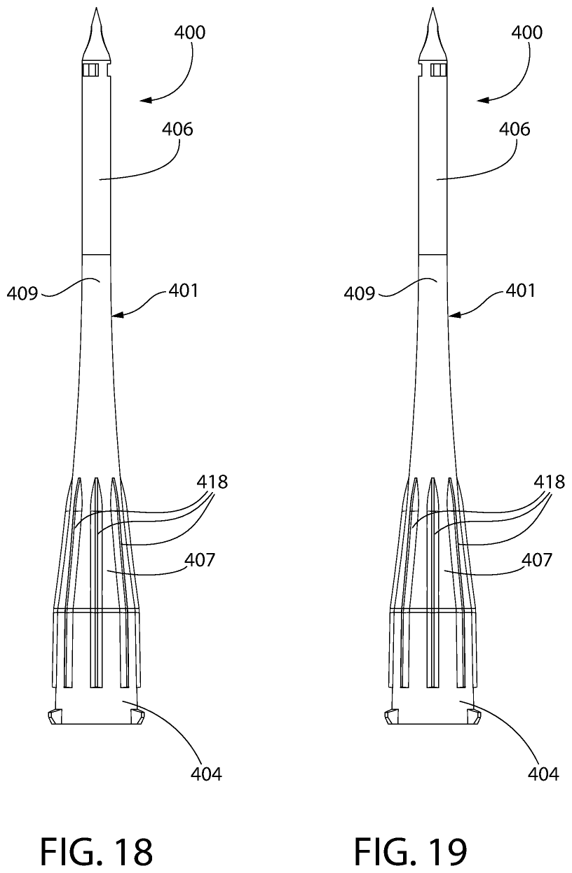

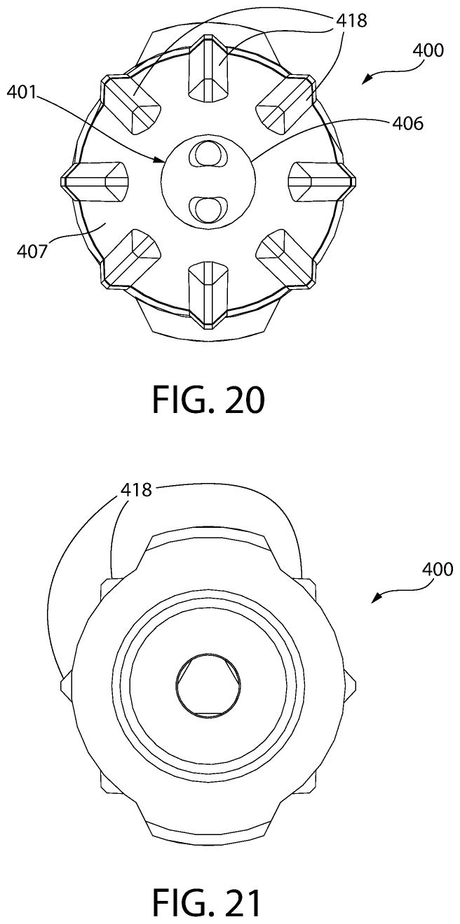

FIGS. 14-21 show various views of another needle 400, in accordance with another non-limiting embodiment of the disclosed concept. Similar or identical structure between the embodiments of FIGS. 1-9 and FIGS. 14-21 is distinguished in FIGS. 14-21 by a reference number with a magnitude four hundred (400) greater than that of FIGS. 1-9. Description of certain similarities between the embodiments may be omitted herein for convenience and brevity only.

Needle 400 is constructed of the same material as, and made by the same processes as, needles 100, 300, discussed above. Additionally, needle 400 has portions (e.g., proximate the sharp, shown but not labeled) structured substantially the same as needles 100, 300. As such, advantages associated with needles 100, 300 likewise apply to needle 400. One optional difference between needle 400 and needle 300 is the inclusion of three spaced-apart thru holes in the sidewall of the needle 400, all of which are equally spaced-apart from the sharp.

As shown, tubular sidewall 406 of needle body 401 optionally has a tapered portion 407. In one example embodiment, tapered portion 407 extends from, and narrows from, near proximal end portion 404 to near or beyond a midpoint 409 of tubular sidewall 406. As a result of this configuration, tubular sidewall 406 is at least slightly wider proximate proximal end portion 404 than at midpoint 409. Optionally, protrusions 418 taper, or narrow, from proximal end portion 404 toward midpoint 409. Alternatively, protrusions 418 are a consistent size and shape from the proximal end portion 404 to midpoint 409. In one embodiment, each protrusion 418 has a triangular cross-sectional shape.

The disclosed configuration of needle 400 advantageously provides increased strength and resistance to fracture when needle 400 is used in operation. Specifically, by having a relatively wide or thick intersection between tubular sidewall 406 and proximal end portion 404, greater forces would be required to fracture tubular sidewall 406 from proximal end portion 404, as compared to, for example, needles 100, 300, in which the outer diameters of their tubular sidewalls are generally constant from proximate sharps 102, 302 to proximate proximal end portions 104 (e.g., and the proximal end portion of needle 300, shown but not indicated). This embodiment of the needle 400, therefore, is able to withstand more wear-and-tear during use.

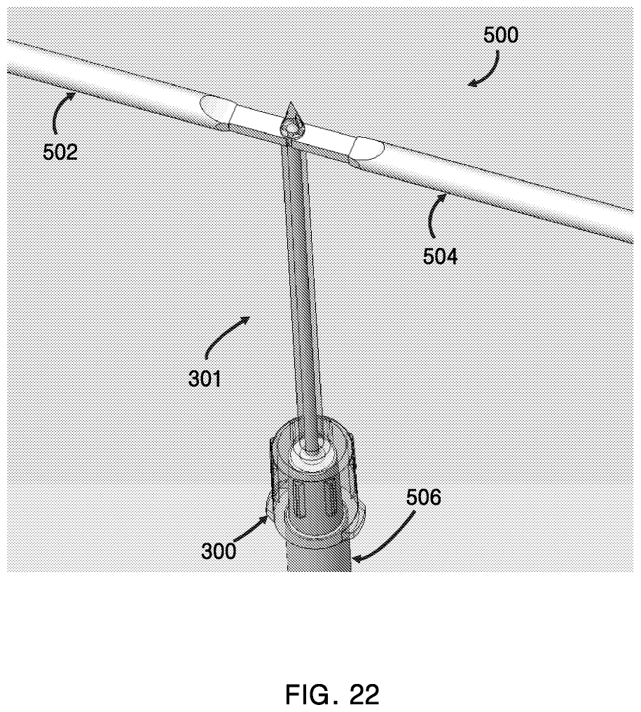

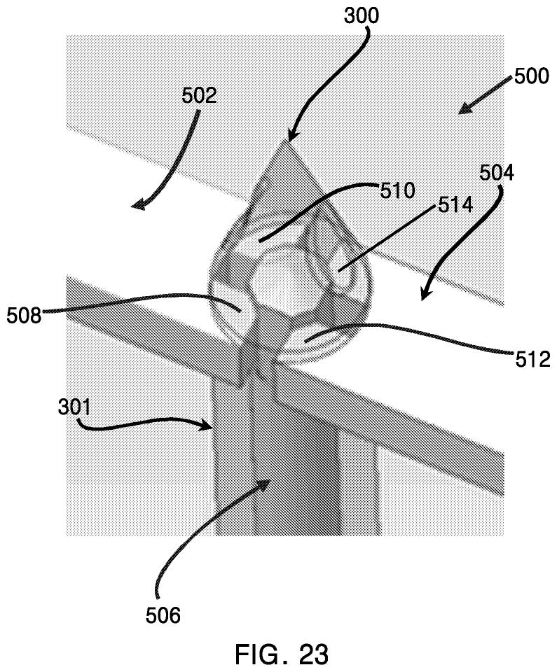

As discussed above, needles 100, 300, 400 may be manufactured by novel injection molding processes. For example, as shown in FIG. 22, needle 300 is formed in a mold 500, wherein portions of mold 500 that surround needle body 301 have been removed for clarity in the figures. Further, as shown, needle 300 is mostly transparent in order to show portions of mold 500. Mold 500 includes a pair of opposing tooling slides or side draws 502, 504 and a tool core 506. In operation, tool core 506 is substantially located internal with respect to needle body 301. Furthermore, tooling slides 502, 504 stabilize tool core 506 and/or create the necessary thru holes (not identified by reference numbers in FIGS. 22 and 23, but see, for example, edge portions 310, 312, 314, 316 in FIGS. 10-12, which each define one the four thru holes).

Referring to FIG. 23, in one embodiment tooling slides 502, 504 each have a corresponding pair of distal protrusions 508, 510, 512, 514 that are configured to be disposed proximate and/or engage tool core 506. In one embodiment, at least a portion of one or more of the distal protrusions 508, 510, 512, 514 has a “V” shape. During formation of needle 300, tooling slides 502, 504 mate with or contact tool core 506, at which point material (e.g., molten plastic) is then injected into mold 500 to form needle 300. After needle 300 is formed, tooling slides 502, 504 retract or move in opposing direction so that needle 300 can be ejected or otherwise removed from tool core 506. In one embodiment, this process forms the needle 300 having a 16 gauge.

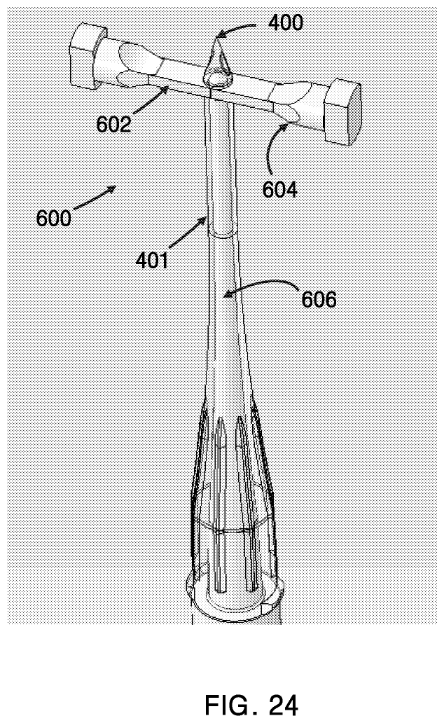

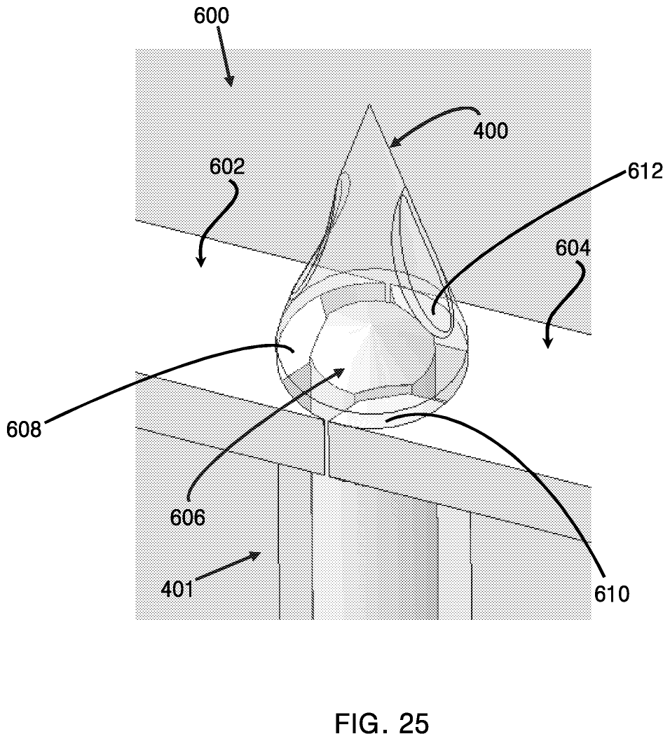

FIGS. 24 and 25 show needle 400 being formed by another mold 600, in accordance with another non-limiting embodiment of the disclosed concept. Mold 600 is similar to mold 500, and like reference numbers represent like components. As shown, tooling slides 602, 604 are configured to stabilize tool core 606, similar to mold 500. However, as shown in FIG. 25, first tooling slide 602 includes a single distal protrusion 608, and second tooling slide 604 includes a pair of distal protrusions 610, 612. As such, mold 600 is configured to form three thru holes in needle body 401 instead of four. Thus, needles in accordance with the disclosed concept may have any suitable number of thru holes provided proximate their sharps.

The disclosed concepts have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of the presently disclosed technology should not be limited by any of the above-described exemplary embodiments, but should be defined only in accordance with the following claims and their equivalents.

What is claimed:

1. A needle comprising:
a hollow needle body comprising:
a sharp having at least one concave recessed region, and
a proximal end portion disposed opposite the sharp and defining an opening,
wherein the needle body has at least one thru hole and a lumen, the at least one thru hole being disposed at or proximate the sharp, the lumen being provided between the at least one thru hole and the opening of the proximal end portion, and
wherein the needle body is constructed of a blend of a polymeric base material providing flexibility, and a fiber material providing rigidity.

2. The needle according to claim 1, wherein the fiber material comprises glass fibers.

3. The needle according to claim 1, wherein the polymeric base material comprises a nylon material.

4. The needle according to claim 3, wherein the blend comprises 75-85% nylon material and 15-25% glass fibers.

5. The needle according to claim 1, wherein the needle body further comprises a tubular sidewall extending from the sharp to the proximal end portion, wherein the tubular sidewall has a distal portion from which the sharp distally extends and wherein the at least one thru hole is provided through the distal portion wherein the proximal end portion has a first outer diameter and wherein the tubular sidewall has a second outer diameter that is less than the first outer diameter.

6. (canceled)

7. The needle according to claim 5, wherein the tubular sidewall has a tapered portion narrowing from proximate the proximal end portion to proximate a midpoint of the tubular sidewall.

8. The needle according to claim 1, wherein the at least one thru hole consists of a first thru hole and a second thru hole disposed opposite the first thru hole.

9. The needle according to claim 1, wherein the needle body comprises a plurality of spaced-apart protrusions extending outwardly from the proximal end portion.

10. (canceled)

11. The needle according to claim 1, wherein the sharp has a plurality of concave recessed regions.

12. A needle assembly comprising:
a container body defining an interior; and
the needle according to claim 1, the needle body being disposed within the interior of the container body.

13. The needle assembly according to claim 12, wherein the container body comprises a first end portion and a plurality of spaced-apart protrusions extending inwardly from the first end portion; and wherein the plurality of spaced-apart protrusions of the first end portion of the container body interlocks with the proximal end portion of the needle body, the needle assembly further comprising a lid coupled to the container body, wherein the lid and the container body are cooperatively structured to enclose the needle body.

14. (canceled)

15. The needle assembly according to claim 13, wherein the container body comprises a second end portion disposed opposite the first end portion of the container body, an inner surface extending from the first end portion of the container body to the second end portion of the container body, and a plurality of guide rail portions each extending radially inwardly from the inner surface, wherein each of the plurality of guide rail portions extend from proximate the first end portion of the container body to proximate the second end portion of the container body, wherein the needle body further comprises a tubular sidewall extending from the sharp to the end portion of the needle body, wherein the tubular sidewall is centrally disposed with respect to the plurality of guide rail portions.

16. (canceled)

17. (canceled)

18. A method of using the needle assembly according to claim 12, the method comprising:
opening a lid connected to the container body to provide access to the needle body;
coupling a device to the proximal end portion of the needle body to provide a fluid fitting configured for facilitating fluid communication from the needle to a receiving enclosure to which the device is connected;
removing the needle body from the container body;
inserting the sharp into a liquid-holding dispensing enclosure, wherein the liquid-holding dispensing enclosure comprises a fluid receiver fitting having a septum and wherein the inserting step comprises piercing the septum with the sharp; and
withdrawing a quantity of the liquid from the liquid-holding dispensing enclosure, the quantity of liquid passing through the at least one thru hole and into the lumen.

19. (canceled)

20. The method according to claim 18, wherein the septum has a penetration surface disposed in a plane, wherein the piercing step comprises piercing the penetration surface and wherein, when the sharp pierces the penetration surface, the needle body is disposed at an angle of from 40° to 75° with respect to the plane.

21. A method of manufacturing a needle, the method comprising:
providing a mold defining a cavity corresponding to a profile of a needle body;
injecting a blend of a polymeric material and a fiber material into the cavity, the blend comprising 75-85% nylon material and 15-25% glass fibers;
allowing the blend to harden; and
removing the blend from the cavity.

22.-24. (canceled)

25. A needle comprising:
a needle body having a distal end, an opposing proximal end, and a tubular sidewall extending therebetween, at least a distal portion of the sidewall extending parallel to a longitudinal axis of the needle body, the proximal end including an opening, a sharp having a conical shape extending from the distal end, the sharp including at least one concave recessed region, the tubular sidewall defining a lumen through the needle body, at least two holes extending through the tubular sidewall, the lumen extending from the opening to the at least two holes, wherein the at least two holes are located closer to the distal end than the proximal end along the longitudinal axis and wherein no holes are located in the sharp.

26.-30. (canceled)

31. The needle according to claim 25, wherein the at least two holes extend perpendicularly to the longitudinal axis.

32. The needle according to claim 25, wherein the needle body is constructed of a blend of a polymeric base material formed of nylon material providing flexibility, and a glass fiber material providing rigidity.

33. The needle according to claim 32, wherein the blend comprises 75-85% nylon material and 15-25% glass fiber material.

34. (canceled)

35. The needle according to claim 25, wherein the tubular sidewall includes a tapered portion.
